(19) United States
(12) Patent Application Publication
(10) Pub. No.: US 2003/0131534 A1
(43) Pub. Date: Jul. 17, 2003

(54) Door with adjustable guide rail and corresponding method of assembly

(76) Inventors: Patrice Cardine, Orleans (FR); Denis Chevy, Neuvy en Sullias (FR)

Correspondence Address: CARLSON, GASKEY & OLDS, P.C., 400 WEST MAPLE ROAD, SUITE 350, BIRMINGHAM, MI, 48009, US

(21) Appl. No.: 10/340,039

(22) Filed: Jan. 10, 2003

(30) Foreign Application Priority Data
Jan. 11, 2002 (FR) 02 00 304

(51) Int. Cl. E05D 15/10

(52) U.S. Cl. 49/212; 49/348

(57) ABSTRACT

A window lifter comprises at least one panel, a rail for guiding a slider, an attachment of the lower end of the rail to the panel, able selectively to cause the rail to slide transversely with respect to the panel, and a one-piece attachment of the upper end of the rail to the panel, able to cause the upper end of the rail to pivot with respect to the panel about a longitudinal axis. This window lifter makes it possible to reduce the number of parts in a window lifter and makes it easier to assemble.

This application claims priority to French Patent Application 02 00 304 filed Jan. 11, 2002.

### BACKGROUND OF THE INVENTION

The invention relates to car doors and window lifters, and in particular to doors and window lifters of cabriolets or convertibles.

Cabriolets are known, in particular the vehicle marketed by Peugeot under the name Peugeot 206CC, in which the door has no window surround. In this case, it is then particularly important to be able to adjust the position of the top of the window by a few millimeters in the transverse direction of the vehicle. This adjustment makes it possible to obtain a good seal at the periphery of the door window and to compensate for assembly spread.

Peugeot markets a vehicle under the name Peugeot 206CC, equipped with a door window lifter that has a rail that is adjustable in the transverse direction. The window lifter comprises two rails extending vertically inside a front door. These rails have a slider guide groove. Each rail has an upper attachment and a lower attachment with the door or the chassis. The lower attachment allows the lower part of the rail to be moved in the transverse direction of the vehicle. The upper attachment is rigid.

That device has disadvantages. Specifically, when the window lifter is being assembled with the door, the transverse movement of the lower part of the rail during the adjusting step causes the rail to pivot under stress about a longitudinal axis of the vehicle, this axis lying approximately at the upper fixing. Because of the fixedness of the upper attachment, the transverse position of the window is thus adjusted by forcing it, and this generates deformation in the geometry of the rail and/or of the door. This deformation is the seat of poor window lifter adjustment efficiency. In addition, this device requires a significant movement of the lower part of the rail, and therefore significant deformation of the rail, in order to allow the top of the window to be adjusted by a small amount.

Alfa Romeo markets a vehicle under the name of The Spider. The door of this vehicle has no window surround. This door is equipped with a window lifter with a sector-arm and two guide rails which are adjustable in the transverse direction. The window lifter comprises two rails running vertically inside a front door. These rails have a slider guide groove. Each rail has an upper attachment and a lower attachment with the door or the chassis. The lower attachment allows the lower part of the rail to be moved in the transverse direction of the vehicle. The upper attachment of each rail consists of a lug for fixing to the door, of a lug for fixing to the rail, and of a rivet articulating the two lugs. The rivet allows pivoting about a longitudinal axis of the vehicle when the lower attachment is moved in the transverse direction.

That device has disadvantages. In particular, that device comprises many parts, which means high cost and complicated assembly.

There is therefore a need for a window lifter which solves one or more of these problems.

### SUMMARY OF THE INVENTION

The subject of the invention is thus a window lifter comprising at least one panel, a rail for guiding a slider, an attachment of the lower end of the rail to the panel, able selectively to cause the rail to slide transversely with respect to the panel, a one-piece attachment of the upper end of the rail to the panel, able to cause the upper end of the rail to pivot with respect to the panel about a longitudinal axis.

In an alternative form, the attachment of the upper end of the rail has a panel-fixing part and a rail-fixing part that can pivot with respect to the panel-fixing part.

According to another alternative form, the panel-fixing part has a reinforcement.

According to yet another alternative form, the reinforcement comprises a transversely directed rib.

According to yet another alternative form, the rail-fixing part has a reinforcement.

Provision is also made for the reinforcement to comprise a transversely directed rib.

According to an alternative form, the attachment of the upper end of the rail has a region joining the rail-fixing part and the panel-fixing part, the cross section of which region is smaller than the mean section of the panel-fixing and rail-fixing parts.

According to another alternative form, the upper attachment has a predeformation so as to guarantee the pivoting.

According to yet another alternative form, the predeformation can be obtained by pressing.

According to yet another alternative form, the panel-fixing part has a flat region roughly parallel to the panel.

Provision is also made for the window lifter further to comprise a cable turn element fixed to the rail-fixing part.

According to an alternative form, the window lifter further comprises an element for receiving the end of the cable sheath of one piece with the rail-fixing part.

According to another alternative form, the upper attachment is of one piece with the tail.

### BRIEF DESCRIPTION OF THE DRAWINGS

Other features and advantages of the invention will become apparent from reading the description which follows of some embodiments of the invention, which description is given merely by way of example with reference to the appended drawings which show:

FIG. 1, a sectional depiction of a window lifter according to the invention;

FIG. 2, a perspective depiction of an attachment of the upper end of the rail to a panel.

### DETAILED DESCRIPTION OF THE PREFERRED EMBODIMENT

The invention thus provides a window lifter equipped with a lower attachment sliding transversely and with an upper attachment having, in a one-piece way, a rail-fixing part and a panel-fixing part. The rail-fixing and panel-fixing parts can pivot one with respect to the other. This result is obtained in particular by using rail-fixing and panel-fixing parts which are more rigid than the region which joins them.

In the description which follows, the transverse direction corresponds to the normal to the mean plane of the door or of a lateral bodywork panel as appropriate. The longitudinal and vertical directions correspond to the longitudinal and vertical directions of the vehicle in which the window lifter is mounted.

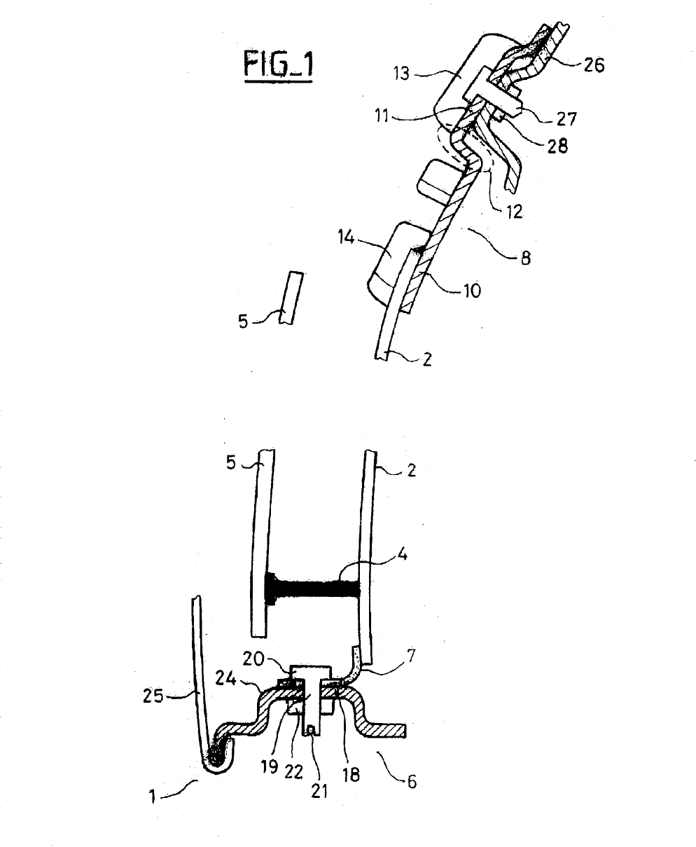

FIG. 1 shows a window lifter 1 according to the invention comprising a window lifter rail 2. The window lifter rail 2 has a guide groove (not depicted) for a slider 4. The guide groove allows the slider to slide over the upward and downward travel of the slider 4. The slider 4 is secured to a window glass 5. The window lifter has an attachment 6 of the lower end of the rail 2 to an outer panel 25. Of course, provision could be made for the attachment 6 to provide the connection between the rail 2 and an inner panel or a structural element 26 in place of or as well as the outer panel 25. The window lifter also has an attachment 8 of an upper end of the rail to an inner panel or to a structural element of the door or of the vehicle 26. This may, for example, be an attachment of the rail to the upper edge of the door. The reference 26 hereinafter will denote an inner panel, for the purposes of simplification.

The lower attachment 6 allows the rail to slide in the transverse direction. This sliding allows the transverse position of the top of the window glass 5 to be altered. One example of an attachment allowing the rail to slide with respect to the panel will be detailed later on.

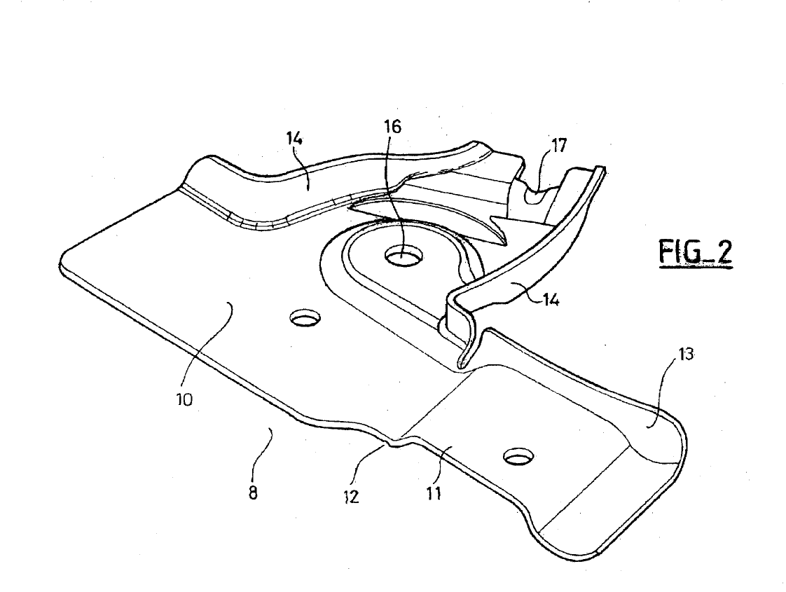

FIG. 2 is a perspective view of the attachment 8. The attachment 8 of the upper end of the rail has a rail-fixing part 10 and a panel-fixing part 11. The panel-fixing part 11 is fixed, in the example by a screw 27 and a nut 28, to the inner panel 26. Of course any other type of fixing such as welding, riveting or some other type of screwing may be anticipated. The rail-fixing part 10 is fixed to the guide rail, possibly by welding or by any other appropriate means or is of one piece with the rail. The two parts 10 and 11 depicted are thus of one piece. The rail-fixing part may also be of one piece with the rail, advantageously when a pressed rail is used. The number of elements in the window lifter is thus reduced. The cost of the parts and of assembling the window lifter is thus reduced. These two parts are also able to pivot one with respect to the other about a longitudinal axis. Thus, when the lower end of the rail is moved transversely, the upper part of the rail can pivot with respect to the panel 26 without leading to deformation of the rail. For a given displacement of the lower end of the rail, the transverse displacement of the upper end of the window glass is also greater because of the pivoting about the longitudinal axis between the rail-fixing and panel-fixing parts 10 and 11.

When the rail-fixing and panel-fixing parts are fixed to the rail and to the panel, the pivoting between the rail-fixing part and the panel-fixing part is blocked by the preventing of the lower attachment 6 from moving translationally.

As depicted, use may be made of fixing parts 10 and 11 each having a part which is roughly flat and parallel to the window glass 5. The pivoting between the rail-fixing and panel-fixing parts is afforded, in the example, by means of a predeformation of the material of the attachment. This predeformation is, for example, achieved by pressing. The region 12, outlined in dotted lines, of the upper attachment 8 is thus a region that is predeformed by pressing. The region 12 thus has a cross section, in a plane containing the transverse and vertical axes, that is curved. The pivoting may thus be afforded by plastic or elastic deformation of the attachment in this region, depending on the materials and on the geometry of the attachment. Furthermore, such a predeformed joining region 12 also has good ability to withstand force in the transverse direction.

The pivoting between the fixing parts 10 and 11 may also be afforded by means of a thinning of the region 12 joining the rail-fixing region 10 and the panel-fixing region 11. The upper attachment 8 therefore has a region joining the rail-fixing part and the panel-fixing part, the cross section of which region is smaller than the mean section of the rail-fixing and panel-fixing parts. This alternative form is particularly advantageous when use is made of an upper attachment 8 having a roughly flat joining region 12 between the fixing parts 10 and 11.

The panel-fixing part 111 preferably has a reinforcement. This reinforcement on the one hand allows the pivoting deformations of the attachment to be concentrated into the joining region 12. On the other hand, in cases where the window lifter is mounted in a door, the reinforcement allows the attachment to withstand forces in the transverse direction. These forces are particularly high when the door is being closed. The reinforcement of the panel-fixing part is, for example, produced in the form of a transversely directed rib 13. Such a form is particularly suitable when the attachment is made by stamping a metal sheet. The rib preferably extends along a plane perpendicular to the longitudinal direction. The panel-fixing part thus flexes less about the longitudinal axis when loaded.

The rail-fixing part 10 may also have a reinforcement 14. This reinforcement 14 also allows the deformations of pivoting of the attachment 8 to be concentrated into the joining region 12. The pivoting between the fixing parts 10 and 11 can thus be achieved with less deformation of the fixing parts 10 and 11 and of the rail 2.

According to an alternative form, it is also possible to anticipate fixing a cable turn element of a type known per se to the rail-fixing part. It is preferable for such a turn element to be fixed to the rail-fixing part. As this fixing part 10 is secured to the rail, the cabling of the window lifter will be practically uninfluenced by the adjustment of the position of the rail of the window lifter. The attachment 8 may thus have a bore 16 for fixing the turn element or a shaft of a turn pulley.

The attachment may also have an element 17 for receiving one end of a cable sheath. This receiving element 17 may have a stop for the end of the sheath and a cable passage next to the stop.

A detailed example of a lower attachment 6 of a rail will now be given. The lower attachment 6 is made, for example, by means of a lug 7 fixed to the rail 2 and of a bridge 24. This lug 7 is arranged approximately at right angles to the rail 2. The lug 7 has an oblong hole 18 extending in the transverse direction of the door or of the chassis as appropriate. A double-headed screw 19 is inserted into the oblong hole 18.

The screw 19 has an upper head 20 and a lower head 21. The thread of the screw is inserted into a screw thread of a corresponding nut 22. The nut 22 is fixed by welding to a bridge 24. The bridge 24 is preferably made in the bottom of the door, in the region where the lower end of the rail 2 is to be situated. The nut 22 is fixed to a flat surface or to a plate of the bridge 24.

The lug 7 may, for example, be produced in a fold of the sheet metal of the guide rail or with an attached and welded part, as appropriate. The upper surface of the lug forms a bearing surface for the upper screw head 20, so that this screw head 20 can apply a compression force to the lug 7. The underside of the lug forms a bearing surface to come into contact with a corresponding surface of the bridge 24.

The oblong hole 18 allows the guide to be slid transversely with respect to the screw during adjustment. Thus, when the screw 19 is held in place without being tightened, the lug 7 is free to slide to fix the transverse position of the rail 2 with respect to the outer panel 25. The transverse position of the window glass can therefore be altered in this way.

When a tightening force is applied between the nut and the screw, the contacting surfaces of the bridge and of the lug respectively are immobilized by friction. It is also possible to anticipate immobilizing the surfaces of the bridge and of the lug respectively using appropriate stops if the friction force between the bridge and the lug proves to be insufficient.

Of course, the present invention is not restricted to the examples and embodiments described and depicted but can be varied in numerous ways accessible to those skilled in the art. Thus, the invention is not restricted to a metal attachment of the upper end of the rail. The assembly of this attachment to the rail and to a panel may also be achieved in any appropriate way, according to the respective materials selected for the rail, the panel or this attachment, without departing from the scope of the invention.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A window lifter comprising:
at least one panel;
a rail for guiding a slider;
an attachment of the lower end of the rail to the panel to selectively cause the rail to slide transversely with respect to the panel;
a one-piece attachment of the upper end of the rail to the panel, to cause the upper end of the rail to pivot with respect to the panel about a longitudinal axis.

2. The window lifter of claim 1, wherein the one-piece attachment of the upper end of the rail has a panel-fixing part and a rail-fixing part, and the rail-fixing part can pivot with respect to the panel-fixing part.

3. The window lifter of claim 2, wherein the panel-fixing part has a reinforcement.

4. The window lifter of claim 3, wherein the reinforcement is a transversely directed rib.

5. The window lifter of claim 1, wherein the rail-fixing part has a reinforcement.

6. The window lifter of claim 5, wherein the reinforcement is a transversely directed rib.

7. The window lifter of claim 1, wherein the one-piece attachment of the upper end of the rail has a region joining the rail-fixing part and the panel-fixing part, and the cross section of which region is smaller than the mean section of the panel-fixing and rail-fixing parts.

8. The window lifter of claim 1, wherein the one-piece attachment of the upper end has a predeformation to allow pivoting.

9. The window lifter of claim 8, wherein the predeformation is obtained by pressing.

10. The window lifter of claim 2, wherein the panel-fixing part has a flat region roughly parallel to the panel.

11. The window lifter of claim 2, further comprising a cable turn element fixed to the rail-fixing part of the one-piece attachment of the upper end.

12. The window lifter of claim 2, wherein the rail-fixing part includes an element that receives an end of a cable sheath.

13. The window lifter of claim 1, wherein the one-piece attachment of the upper end is integral with the rail.
